(19) United States
(12) Patent Application Publication
(10) Pub. No.: US 2020/0139291 A1
(43) Pub. Date: May 7, 2020

(54) WET-LAID NON-WOVEN FABRIC FOR HYDROCARBON TRAP OF AIR CLEANER FOR GASOLINE ENGINE AND MANUFACTURING METHOD THEREOF

(71) Applicant: SUNG CHANG AUTOTECH CO., LTD., Gyeonggi-do (KR)

(72) Inventors: Kwang Jin Joo, Gyeonggi-do (KR); Jae Min Lee, Jeollabuk-do (KR); Young Seop Lee, Gyeonggi-do (KR); Hye-Joon Park, Gwangju (KR)

(21) Appl. No.: 16/181,070

(22) Filed: Nov. 5, 2018

(51) Int. Cl. B01D 53/04; B01J 20/20; B01J 20/30; B01J 20/28; F02M 25/08

(52) U.S. Cl. CPC B01D 53/04; B01J 20/20; B01J 20/3035; B01J 20/3078; B01J 20/3007; B01J 20/28033; B01D 2259/4516; B01J 20/2803; F02M 25/08; B01D 2253/25; B01D 2253/102; B01D 2253/202; B01D 2257/702; B01J 20/3042

(57) ABSTRACT

The present invention provides a wet-laid non-woven fabric for a hydrocarbon trap of an air cleaner or gasoline engine, wherein powdery activated carbon having specific physical properties, pulp, a synthetic fiber having specific physical properties and a carbon binder are used as basic materials to prepare a web type non-woven fabric; and this fabric is formed into a wet-laid non-woven fabric having a predetermined thickness through compressing, so that: when using the fabric in an air cleaner, this may adsorb volatile oil vapor such as hydrocarbon contained in evaporation gases generated from a fuel of the engine, and then, desorb the same when driving the engine, thereby preventing outflow of the hydrocarbon as a main cause of air pollution to an outside; and further, damage to a passenger in a vehicle due to hydrocarbon gas may be minimized, and a manufacturing method thereof.

### BACKGROUND OF THE INVENTION

### 1. Field of the Invention

The present invention relates to a wet-laid non-woven fabric for a hydrocarbon trap of an air cleaner for a gasoline engine, and manufacturing method thereof, and more particularly, to a wet-laid non-woven fabric for a hydrocarbon trap with remarkably improved adsorption/desorption abilities as well as excellent physical properties, wherein the wet-laid non-woven fabric is formed by selecting powdery activated carbon having a meso-structure in a predetermined range and a synthetic fiber having specific physical properties, and then, minimizing consumption of a carbon binder, thereby accomplishing excellent physical properties and noticeably improved adsorption/desorption abilities such as prevention of release of powdery activated carbon, etc. during adsorption and desorption of volatile oil vapor, for example, hydrocarbon gas, when a hydrocarbon trap of an air cleaner for a gasoline engine is manufactured using the wet-laid non-woven fabric, and then used, and a manufacturing method thereof.

### 2. Description of the Related Art

In general, a vehicle generates power by mixing and combusting a fuel and air in an engine.

In other words, a fuel stored in a fuel tank of the vehicle passes through a variety of fuel supply apparatuses, is mixed with air inflowing from an outside and injected into an engine cylinder, and the engine is actuated while repeating intake, compression, explosion and exhaust strokes. Accordingly, the vehicle gets power from the engine.

In order to operate the engine for driving the vehicle as described above, a certain amount of air is required and this air is introduced and supplied from the outside of the vehicle.

That is, the air inflowing from the outside of the vehicle toward an air cleaner moves to an intake manifold through an intake hose connected to the air cleaner, and then is supplied to the engine.

In this case, an air cleaner filter for filtering dust and foreign substances contained in external air is provided inside the air cleaner in order to filter the dust, the foreign substances, and the like, contained in the external air, thereby supplying clean air required for combustion and operation of the engine.

Such an air cleaner is provided with an inlet port able to be coupled to an end of the air intake hose, wherein a diffuser is connected inside the air cleaner.

Meanwhile, hydrocarbon gas among harmful gases exhausted during driving or stoppage of the vehicle is one of air pollutants that are discharged to the atmosphere and chemically reacted with ozone in the atmosphere to cause photochemical smog. The hydrocarbon gas is leaked near an air intake system (e.g., an air duct, an air cleaner, an air intake hose, or a throttle body, etc.) to cause a problem harmful to animals, plants and humans, and is a seriously harmful gas causing air pollution problems. Therefore, there is a need for an apparatus capable of adsorbing the hydrogen gas described above.

In other words, an air cleaner filter mounted in the air cleaner as the air intake system described above, serves to filter foreign substances such as dust contained in air supplied to the inside of the vehicle.

However, the conventional air cleaner does not have a separate filter to capture hydrocarbon gas, thereby causing a problem that the hydrocarbon gas contained in evaporation gases generated in an engine, etc. could not be captured by only the conventional air filter.

That is, it is difficult to collect or capture hydrocarbon gas contained in evaporation gases generated from residual fuel in the engine etc. by the conventional air cleaner provided with only a typical air cleaner filter as described above, thereby causing a problem of directly discharging the hydrocarbon gas to the atmosphere.

In addition, as a law for vehicle exhaust gas emissions is strengthened recently in advanced countries such as United States, etc., a need for supplying vehicles satisfying regulations on the exhaust gas is increased.

In particular, due to the strengthened regulations on fuel evaporation gas generated from the residual fuel during starting or stopping the engine and remaining in the engine or an intake system, and then, discharged to the atmosphere through the intake system, that is, hydrocarbon gas (HC), it is a trend to gradually increase the number of obligation sales of vehicles equipped with a hydrocarbon gas collection device.

Therefore, in order to export vehicles to the advanced countries, there is a need for the vehicles to mount a hydrocarbon gas collection device with high efficiency in the air intake system.

Among existing techniques for manufacturing a hydrocarbon trap for an air cleaner, Korean Patent Registration No. 10-749608 proposes a hydrocarbon trap of an air cleaner, characterized by including a filter assembly which includes: an air cleaner body in which an air cleaner filter is mounted; a first porous foam type filter layer mounted on an air cleaner cover coupled to a top of the air cleaner body; a second porous foam type filter layer closely adhered to a top of the first filter layer and having a larger thickness than the first filter layer wherein hydrocarbon gas is desorbed from the second filter layer; third and fourth porous foam type filter layers closely adhered to a top of the second filter layer; and wire meshes located so as to house the first to fourth filter layers therein, with being closely coupled to the first to fourth filter layers, wherein outer peripheries of the first to fourth filter layers and the wire meshes are fixed so as to be closely adhered to each other by heat or ultrasonic compression the same.

The above-described hydrocarbon trap is expected to have adsorption/desorption effects of volatile oil vapor in some degree, however, there are problems that a manufacturing process thereof is too complicated, and the trap has a complicated structure and some deterioration in performance.

In addition, Korean Patent Laid-Open Publication No. 10-2017-0025376 proposes a method for manufacturing a wet-laid non-woven fabric having a predetermined thickness, which includes the processes of: mixing basic materials such as powdery activated carbon, pulp and a synthetic fiber, and additives such as a dispersant, a water repellent agent, a wet light trapping agent, a sizing agent and/or a carbon fixing agent to prepare a composition; and compressing the prepared composition.

The above-described technique may be appreciated as a significantly improved technique compared to the existing non-woven fabric for a hydrocarbon trap. However, even using the carbon fixing agent, there is still a problem that release of the activated carbon occurs to cause quality failure. Due to no consideration of compatibility between the activated carbon with limited adsorption ability and the synthetic fiber, other problems such as limited adsorption/desorption abilities of volatile oil vapor and poor quality caused by releasing the activated carbon have been newly on the rise.

As another technique similar to the above technique, Japanese Patent Laid-Open Publication No. 2000-024426 discloses an adsorptive sheet including a granular activated carbon-containing sheet, which is not mounted on the air cleaner but used for the purpose of air purification. The granular activated carbon-containing sheet is provided in a type of an adsorptive sheet which includes granular activated carbon having an average particle diameter of 100 to 600 μm, a support fiber that contacts to the granular activated carbon to fix the same, and an adhesive fiber that mainly serves to maintain a shape thereof.

However, the above-described technique is to propose an air purification filter having good air ventilation and excellent dust removal ability maintained for a long period of time. This relates to a simple filter configuration having the purpose of air purification and dust removal, which are absolutely different functions from those of the hydrocarbon trap for an air cleaner that repeatedly conducts adsorption/desorption of volatile oil vapor. Therefore, the above technique cannot be applied to hydrocarbon trap products.

As such, in a case of a filter body for a hydrocarbon trap of an air cleaner which is mounted in the conventional air cleaner, there is still a need for continuous research and development in regard to improvement of performance or failure rate.

### PRIOR ART DOCUMENT

### Patent Document

(Patent Document 1) Korean Patent Registration No. 10-749608

(Patent Document 2) Korean Patent Laid-Open Publication No. 10-2017-0025376

(Patent Document 3) Japanese Patent Laid-open Publication No. 2000-024426

### SUMMARY OF THE INVENTION

In order to solve the above-mentioned problems, the present invention has a technical task to be solved that provides a wet-laid non-woven fabric for a hydrocarbon trap of an air cleaner for a gasoline engine, which has a novel configuration for attaining improved physical properties, excellent durability and remarkably improved adsorption/desorption abilities to volatile oil vapor such as hydrocarbon contained in evaporation gases generated from a fuel in a combustion chamber of an engine and/or a fuel storage tank.

Accordingly, it is an object of the present invention to provide a wet-laid non-woven fabric for a hydrocarbon trap with improved adsorption/desorption abilities of volatile oil vapor, which is mounted in an air cleaner for a gasoline engine to prevent release of activated carbon, wherein the activated carbon having specific physical properties as well as a synthetic fiber having specific physical properties are suitably selected and used, and a minimum amount of a carbon binder is mixed thereto to produce the wet-laid non-woven fabric.

In addition, another object of the present invention is to provide a wet-laid non-woven fabric for a hydrocarbon trap of an air cleaner for a gasoline engine, with remarkably improved adsorption/desorption abilities of volatile oil vapor from gasoline, which has a new configuration so that: hydrocarbon in evaporation gases discharged during driving or stoppage of a vehicle is captured to prevent release of hydrocarbon which is a main cause of air pollution to an outside; and damage caused by the hydrocarbon to a passenger in the vehicle may be minimized.

Further, another object of the present invention is to provide a method for manufacturing a wet-laid non-woven fabric for a hydrocarbon trap of an air cleaner for a gasoline engine with a new configuration, which includes: mixing activated carbon having specific physical properties, and synthetic fiber having specific physical properties together with pulp and a carbon binder in a predetermined mixing ratio; and then heat pressing the same to produce the wet-laid non-woven fabric.

In order to achieve the above-described objects, according to an aspect of the present invention, there is provided a wet-laid non-woven fabric for a hydrocarbon trap of an air cleaner for a gasoline engine, which is installed in the air cleaner for a gasoline engine to capture hydrocarbon in evaporation gases generated from a fuel in a combustion chamber of an engine or a fuel storage tank during driving or stoppage of a vehicle, or to recover the captured hydrocarbon to the engine so as to be reburned therein, the wet-laid non-woven fabric including: basic materials including powdery activated carbon, pulp, a synthetic fiber and a carbon binder, wherein the powdery activated carbon has an average particle size in a range of 20 to 150 μm and contains 45 to 90% of meso-structure, and the synthetic fiber has a diameter of 30 μm or less and a melting point of 110° C. to 270° C.

According to the preferred embodiment of the present invention, the synthetic fiber may use at least one synthetic fiber selected from an ultra-fine fiber, a fine fiber, a split fine type fiber, and a sea-island type fiber; or at least one selected from sheath/core or side by side type composite melting point fibers which are selected from PP/PE, PET/PE, PET/PP and PET/Nylon.

According to the preferred embodiment of the present invention, the basic materials may include 45 to 80 wt. % of the powdery activated carbon, 3 to 13 wt % of the pulp, 10 to 30 wt. % of the synthetic fiber and 3 to 12 wt. % of the carbon binder.

According to the preferred embodiment of the present invention, the basic material may include at least one additive selected from a dispersant, a water repellent agent, a carbon fixing agent and a dehydration enhancer.

In addition, according to the preferred embodiment of the present invention, the additive further included in the basic material may include: at least one of 0.05 to 2.0 wt. % of a dispersant, 0.2 to 1.0 wt. % of a water repellent agent, 0.05 to 1 wt. % of a carbon fixing agent and 0.05 to 1.0 wt. % of a dehydration enhancer based on a total composition of the non-woven fabric.

According to the preferred embodiment of the present invention, preferably, the wet-laid non-woven fabric, which has a weight of 300 to 800 g/m² and a thickness of 2.2 to 3.6 mm before a heat compressing process S150, is pressed and molded so as to have a thickness of 0.6 to 1.8 mm while maintaining the same weight of 300 to 800 g/m² through the heat compressing process S150.

In addition, according to another aspect of the present invention, there is provided a method for manufacturing a wet-laid non-woven fabric for a hydrocarbon trap of an air cleaner for a gasoline engine, which is installed in the air cleaner for a gasoline engine to capture hydrocarbon in evaporation gases generated from a fuel in a combustion chamber of an engine or a fuel storage tank during driving or stoppage of a vehicle or to recover the captured hydrocarbon to the engine so as to be reburned therein, the method including: preparing basic materials which include powdery activated carbon, pulp, a synthetic fiber and a carbon binder, wherein the powdery activated carbon used herein has an average particle size in a range of 20 to 150 μm and contains 45 to 90% of meso-structure, and the synthetic fiber used herein has a diameter of 30 μm in or less and a melting point of 110° C. to 270° C.; passing the basic materials through a suspension process to prepare a suspension S110; subjecting the basic materials passed through the suspension process S110 to a web formation process S120 to form a web type product; subjecting the web type product to a water removal process S130; drying the web type product in a drying process S140 after the water removal process; and subjecting the web type product after the drying process S140 to a heat compressing process S150 to conduct heat compressing and molding, so as to form a sheet type or roll type fabric.

Further, according to another aspect of the present invention, there is provided a hydrocarbon trap of an air cleaner for a gasoline engine, which is produced by using the wet-laid non-woven fabric manufactured as described above.

Effects obtained by the wet-laid non-woven fabric for a hydrocarbon trap of an air cleaner for a gasoline engine according to the present invention, and the hydrocarbon trap applied with the same will be described below.

First, when the wet-laid non-woven fabric according to the present invention is mounted and used on a housing wall or a diffuser of the air cleaner for a gasoline engine, a final product may have excellent durability and remarkably improved adsorption/desorption abilities of volatile oil vapor.

Second, the wet-laid non-woven fabric according to the present invention may be prepared using basic materials such as powdery activated carbon having specific physical properties, pulp, synthetic fiber having specific physical properties and a carbon binder, so as to prevent release of the powdery activated carbon, minimize an amount of the used carbon binder to prevent a meso-structure of the activated carbon from being plugged by the carbon binder, and thereby greatly enhancing butane working capacity (BWC) performance. This effect has been achieved by suitably selecting and using the powdery activated carbon having specific physical properties and the synthetic fiber having specific physical properties to induce synergistic effects, which could not be expected from the related art.

Third, the wet-laid non-woven fabric according to the present invention has remarkably improved adsorption/desorption abilities to volatile oil vapor of gasoline and can capture hydrocarbon in evaporation gases discharged during driving or stoppage of a vehicle, thereby preventing release of hydrocarbon which is a main cause of air pollution to an outside and minimizing damage of the hydrocarbon gas to a passenger in the vehicle.

Fourth, the wet-laid non-woven fabric according to the present invention may have further enhanced functions using additives such as a dispersant, a water repellent agent, a carbon fixing agent, and a dehydration enhancer, etc. Therefore, as compared to the conventional art, using the additives may be useful for a wet-laid non-woven fabric with excellent quality and production of a hydrocarbon trap using the same.

Fifth, the wet-laid non-woven fabric according to the present invention may be compressed to about ½ volume after fabricating the same with a basic structure, so as to minimize a volume of the final product. As a result, when the inventive non-woven fabric is mounted on a housing wall or a diffuser, pressure loss is reduced to save gas mileage compared to the existing bendable non-woven fabric. Further, it is quite advantageous if applying the inventive non-woven fabric to a hydrocarbon trap. Further, since the wet-laid non-woven fabric is formed to have a predetermined thickness, when applying this fabric to the hydrocarbon trap, and using by installing it in an air cleaner housing, adsorption/desorption capacities of volatile oil vapor may be maximized even with a minimum volume.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a process of manufacturing a wet-laid non-woven fabric for a hydrocarbon trap of an air cleaner for a gasoline engine according to the present invention;

FIG. 2A is a photograph illustrating a size distribution of structures of activated carbon for each pore size according to the present invention;

FIG. 2B is a partially enlarged photograph illustrating a pore structure of the activated carbon according to the present invention;

FIG. 2C is a graph illustrating an increase or a decrease (that is, variation) in a pore volume depending on a distribution of meso-structure and micro-structure pores of the activated carbon according to the present invention; and

FIG. 3 is views illustrating cross-sectional structures of fibers preferably applied to a synthetic fiber according to the present invention, which is views conceptually illustrating a variety of shapes of sheath/core or side by side type composite melting point fibers.

### DETAILED DESCRIPTION OF THE INVENTION

Hereinafter, a method for manufacturing a wet-laid non-woven fabric for a hydrocarbon trap of an air cleaner for a gasoline engine, as well as the wet-laid non-woven fabric for a hydrocarbon trap manufactured by the same will be described in detail with reference to accompanying drawings by means of an embodiment.

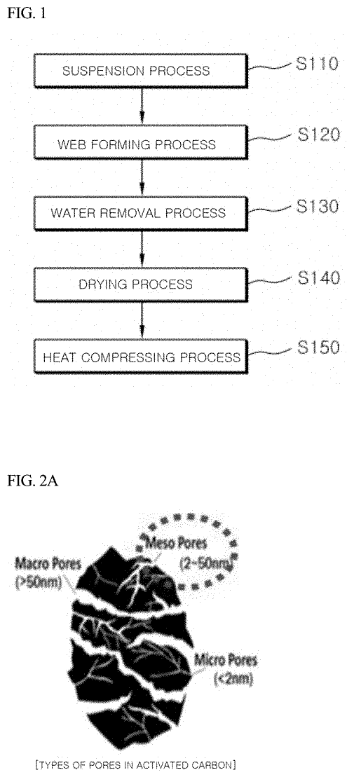

FIG. 1 is a block diagram illustrating a process for manufacturing a wet-laid non-woven fabric for a hydrocarbon trap of an air cleaner for a gasoline engine according to the present invention.

Referring to FIG. 1, the method for manufacturing a wet-laid non-woven fabric for a hydrocarbon trap of an air cleaner for a gasoline engine according to a preferred embodiment of the present invention is illustrated. Herein, the method for manufacturing a wet-laid non-woven fabric is described for each step, wherein the wet-laid non-woven fabric is installed in the air cleaner to capture hydrocarbon in evaporation gases generated from a fuel in a combustion chamber of an engine or a fuel storage tank during driving or stoppage of a vehicle, or to recover the captured hydrocarbon to the engine so as to be rebumed therein.

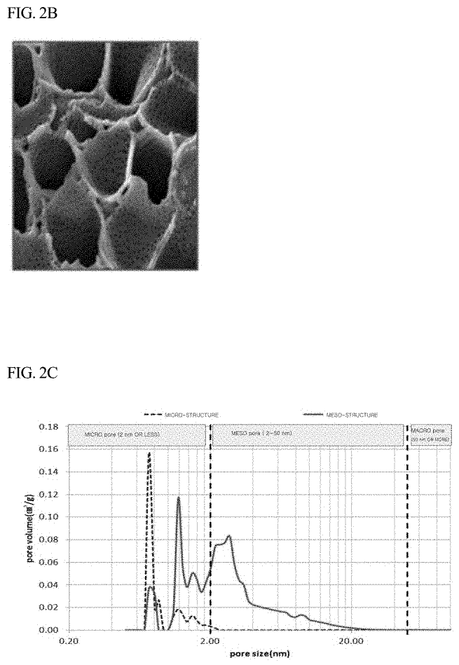

FIG. 2A is a photograph illustrating a size distribution of a meso-structure of activated carbon structures according to the present invention, FIG. 2B is a partially enlarged photograph illustrating a pore structure of the activated carbon according to the present invention, and FIG. 2C is a graph illustrating an increase or a decrease (that is, variation) in a pore volume depending on a distribution in pore sizes of meso-structure and micro-structure pores of the activated carbon according to the present invention.

Referring to FIGS. 2A to 2C, if the distribution of the meso-structure in the activated carbon components according to the preferred embodiment of the present invention is higher, repeatedly using the non-woven fabric is advantageous. Therefore, the above non-woven fabric may be semi-permanently used in repeat processes of absorption-desorption-adsorption-desorption.

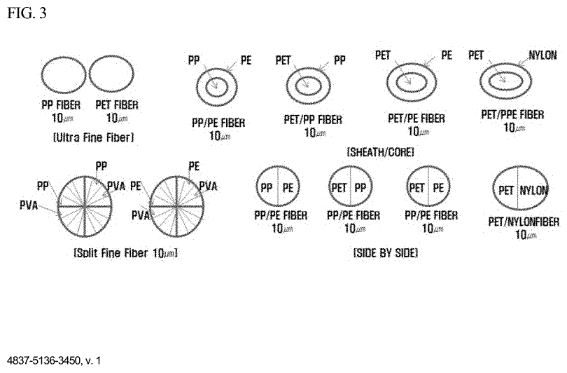

FIG. 3 is views conceptually illustrating a variety of shapes of sheath/core or side by side type composite melting point fibers preferably applied to a synthetic fiber according to the present invention.

Referring to FIG. 3, as the synthetic fiber according to the present invention, when using a synthetic fiber having a diameter of 30 μm or less and a composite melting point fiber, powdery activated carbon may be adhered and bonded to the melting point fiber while isolating the activated carbon between the fibers, so as to prevent release of the activated carbon and allow the activated carbon to be bonded to a specific synthetic fiber, and thereby decreasing a content of the used carbon binder.

Further, the wet-laid non-woven fabric for a hydrocarbon trap of an air cleaner for a gasoline engine, which is produced by the method for manufacturing a wet-laid non-woven fabric for a hydrocarbon trap of an air cleaner for a gasoline engine may be installed in the air cleaner, in particular, may be fixed and mounted on a housing of the air cleaner through ultrasonic fusion.

In this case, the wet-laid non-woven fabric for a hydrocarbon trap of an air cleaner for a gasoline engine according to the present invention may include basic materials including powdery activated carbon, pulp, a synthetic fiber and a carbon binder. Further, the basic material may include at least one additive selected from a dispersant, a water repellent agent, a carbon fixing agent and a dehydration enhancer.

Meanwhile, in order to produce a wet-laid non-woven fabric, the method for manufacturing the same may include: a suspension process S110 of mixing the basic materials described above and the additive as necessary to prepare a suspension; a web formation process S120 of forming the suspension into a web type product; a water removal process S130 performed on the web type product to discharge water; a drying process S140 of drying the same; and a heat compressing process S150 of heat compressing and molding the product after the drying process S140, thereby forming a sheet type or roll type fabric.

According to the preferred embodiment of the present invention, the basic materials may have the most preferable composition of components such as 45 to 80 wt. % of powdery activated carbon, 3 to 13 wt. % of pulp, 10 to 30 wt. % of a synthetic fiber, and 3 to 12 wt. % of a carbon binder.

Further, the additive further included in the basic material preferably may include: 0.05 to 0.2 wt. % of a dispersant; 0.2 to 1.0 wt. % of a water repellent agent; 0.05 to 1.0 wt. % of a carbon fixing agent; and 0.05 to 1.0 wt. % of a dehydration enhancer based on a total composition of the wet-laid non-woven fabric.

According to the preferred embodiment of the present invention, the powdery activated carbon used herein may have an average particle size in a range of 20 to 150 μm. If the particle size is too small, adsorption efficiency is low and it becomes much dusty during production, thus not being preferable. On the other hand, if the particle size is too large, overall adsorption effects may be reduced and the activated carbon powders may be possibly released during the manufacturing process or when using the activated carbon by applying to the trap.

In addition, if the particle size of the activated carbon is less than 20 μm, the activated carbon in a wire suction process to remove water from the suspension for wet-laid non-woven fabric may be drained quite a lot along with the water. Further, if the activated carbon having a particle size of 20 μm is too much, a suction pressure is considerably higher and may make it impossible to manufacture the wet-laid non-woven fabric.

Further, when using the activated carbon having an average particle size of more than 150 μm in a hydrocarbon trap (HC Trap), the activated carbon particles may adversely affect the engine if the activated carbon particles are mixed up into the engine upon occurring vibration after mounting the same in an engine air cleaner.

In other words, if a weight of the activated carbon is low, butane adsorption capacity is also low while a filtration area is increased, and a large amount of the activated carbon is required due to a small space of a housing of the engine air cleaner. On the other hand, if the weight of the activated carbon is too high, an amount of the activated carbon is increased to cause a deterioration in ultrasonic adhesiveness to the housing of the engine air cleaner, and it is difficult to form a housing structure of the engine air cleaner in a plate or circular shape.

The present invention uses pulp. Due to a strong hydrogen bond, the pulp allows smooth transportation of a filter medium in a wet state. Further, powdery activated carbon may be substantially adhered to a plate-shaped pulp structure. Therefore, if an amount of pulp used herein is too small, activated carbon adhesion efficiency is low. On the other hand, if the amount thereof is too large, a high vacuum pressure occurs during a water removal process although the activated carbon is adhered well. As a result, the water is not removed, thereby causing a deterioration in overall adsorption/desorption effects.

According to the preferred embodiment of the present invention, the pulp may typically include NBK (CANFOR Pulp and Paper Co.), but it is not limited thereto.

Further, according to the preferred embodiment of the present invention, powdery activated carbon having a particle size in a range of 20 to 150 μm may be used. In this case, the powdery activated carbon preferably has a specific surface area of 1,000 to 3,000 m²/g, and more preferably, 2,000 to 3,000 m²/g. If the specific surface area thereof is too small, excess of activated carbon should be used. In particular, at largest 2-fold content of the activated carbon needs to be included, thus causing a difficulty in manufacturing a wet-laid non-woven fabric. Further, if the specific surface area thereof is larger than 3,000 m²/g, an apparent density of the activated carbon is increased and a volume thereof becomes large to cause an increase in a thickness of the wet-laid non-woven fabric to be produced. For this reason, a mixing ratio of the melting point fine fibers or a content of the synthetic fiber should be considerably increased more than 30%. In addition, a temperature and a pressure should be further increased in a heat compressing process of the wet-laid non-woven fabric, thus not being preferable.

A fine fiber generally refers to a thread having a thickness of 1 denier (5 μm) or less. Typically, the fine fiber is a fiber developed to have very soft and smooth touch feel. Depending upon splitting a spun fiber, finest fibers with maximum 0.001 denier may be fabricated, which are generally used for artificial suede requiring softness or a cloth for cleaning a lens such as glasses.

In the present disclosure, a ‘melting point fine fiber’ commonly refers to fibers fabricated using a fine fiber, an ultra-fine fiber, a split fine type fiber, and a sea-island type fiber, etc, which have a melting point of 110 to 270° C. and a diameter of 30 μm or less. Any synthetic fiber may be used without particular limitation thereof so far as it can satisfy the above-described melting point and thickness.

The powdery activated carbon used in the present invention should have the above-described specific surface area. Nevertheless, it is preferable that the powdery activated carbon in the present invention has a specific pore structure. The pore structure of the activated carbon used in the present invention may include a meso-structure of 45 to 90%, and preferably, 60 to 90%. If the content of the meso-structure in the powdery activated carbon is less than the above range, an adsorption capacity of the volatile oil vapor is drastically reduced. If the above content is too much, there is a difficulty in production of the activated carbon without any economic advantage. Furthermore, the volatile oil vapor is not adsorbed but may remain after adsorption of the same without further increasing the adsorption capacity.

Herein, the meso-structure means that the activated carbon has a pore size in a range of 2 nm to 50 nm. The present invention may use the powdery activated carbon having the meso-structure in a specific range to remarkably improve characteristics of repetitive adsorption-desorption-adsorption-desorption of volatile oil vapor.

In this regard, FIG. 2A illustrates a distribution of the meso-structure among the pore structures of the activated carbon. In consideration of using the characteristics of repetitive adsorption-desorption-adsorption-desorption of volatile oil vapor by the activated carbon, the distribution of the meso-structure is more significant in the present invention than the micro-structure or meso-structure itself.

In particular, referring to FIG. 2C, it can be seen that that the distribution of the meso-structure in the activated carbon is significant, wherein the graphs illustrate results of experiments for the micro- and meso-pore structures to the activated carbon obtained by using a specific surface area measurement method developed by Brunauer, Emmett and Teller (BET). Among the graphs in FIG. 2C, a dotted line shows the micro-pore structure while a solid line shows the meso-pore structure. Therefore, it could be confirmed that the activated carbon including 45 to 90% of the meso-structure indicated by a longitudinal solid line, which is within a range of hydrocarbon trap (HC Trap), had excellent adsorption/desorption effects.

According to the present invention, the content of the above-described meso-structure in the powdery activated carbon is not absolutely proportional to the specific surface area. Even when the specific surface area is small, the content of the meso-structure may be increased depending on a formation ratio of the macro-structure having a larger diameter than the meso-structure or the micro-structure having a smaller diameter than the meso-structure. On the other hand, even if the specific surface area is large, the meso-structure may be included in a small quantity. A distribution of the content of the meso-structure in the powdery activated carbon and the content of macro- or micro-structure may be varied to a great extent according to a production process and conditions of the activated carbon as well as raw materials thereof.

Therefore, according to the present invention, it is expected that, only when using the powdery activated carbon containing the meso-structure in a content of 45 to 90% among the powdery activated carbons used as the basic materials, synergistic effects for the adsorption/desorption effects of volatile oil vapor may be achieved by other components to be blended, that is, a specific synthetic fiber and an entire composition of the basic materials such as pulp and a carbon binder.

Further, as the specific surface area and the meso-structure of the activated carbon are larger, absorption/desorption abilities of butane are more excellent. Furthermore, if the specific surface area is small and the meso-structure is developed, a weight of the required activated carbon is increased. Therefore, a method for preparation of the activated carbon containing more than 90% meso-structure has no economic advantage, such that there is no effectiveness for accomplishing the objects of the present invention.

Accordingly, the present invention uses the powdery activated carbon having an average particle size in a range of 20 to 150 μm and a specific surface area in a range of 1,000 to 3,000 m²/g, as well as forms a wet-laid non-woven fabric wherein a structure of the activated carbon includes 45 to 90% of meso-structure. Therefore, when using the wet-laid non-woven fabric for a hydrocarbon trap, hydrocarbon contained in evaporation gases generated from a fuel in a combustion chamber of the engine or a fuel storage tank during stoppage of the engine in a vehicle may be efficiently captured and easily desorbed with regard to an entire size regardless of the size of the hydrocarbon.

As such, the evaporation gas generated during startup stoppage of an engine may be formed from the residual fuel around a fuel injector after the startup stoppage of the engine, or the fuel in the combustion chamber of the engine or the fuel storage tank. The evaporation gas includes hydrocarbon gas which is necessary to be captured. According to the present invention, when using a wet-laid non-woven fabric manufactured by using the powdery activated carbon which includes 45 to 90% of meso-structure and has a particle size in a range of 20 to 150 hydrocarbon may be more efficiently captured with regard to an entire size regardless of the size of the hydrocarbon itself.

According to the present invention, the average particle size of the above-described powdery activated carbon and the distribution characteristic of the meso-structure in the same are very important factors in relation to an entire volatile oil vapor adsorption ability of the wet-laid non-woven fabric and quality of hydrocarbon trap. In particular, these factors may also serve as conditions for expecting selective characteristics of the synthetic fiber to be described below as well as synergistic effects of overall quality and adsorption/desorption effects of volatile oil vapor, thus being of great significance.

According to the preferred embodiment of the present invention, the synthetic fiber used herein may have a diameter of 30 μm or less, preferably, 10 μm or less, and a melting point of 110° C. to 270° C. If the diameter thereof is too large or the melting point thereof is not defined within the above range, when the synthetic fiber is used for manufacturing a wet-laid non-woven fabric which in turn is applied to the hydrocarbon trap, release of the activated carbon particles may occur, in the manufacturing of a non-woven fabric by heat pressing, the pressing is not well performed. Further, capturing effects such as prevention of release of the activated carbon particles may be hardly expected. Accordingly, desired quality may not be achieved.

According to the preferred embodiment of the present invention, the synthetic fiber used herein may include, for example, at least one selected from an ultra-fine fiber, a fine fiber, a split fine type fiber, and a sea-island type fiber; or at least one selected from sheath/core or side by side type composite melting point fibers which have a melting point of 110° C. to 270° C. and are selected from PP/PE, PET/PE, PET/PP and PET/Nylon.

Herein, PP, PE and PET refer to polypropylene, polyethylene and polyethylene terephthalate, respectively.

In this regard, FIG. 3 shows a variety of sheath/core type or side by side type composite melting point fibers, in particular, fibers having a fiber diameter of 10 μm, to conceptually illustrate cross-sectional structures of the composite melting point fibers. The synthetic fiber usable in the present invention is not particularly limited thereto, instead, other similar type composite melting point fibers or composite melting point fibers including other similar components may also be used.

Further, according to the present invention, other synthetic fibers may also be used so far as they have a diameter and a melting point within the above-described ranges.

The reason for using the above-described synthetic fibers is that these can prevent release of the powdery activated carbon used together and minimize an amount of the used carbon binder, such that the carbon binder does not hinder the meso-structure of the activated carbon, thus to improve a performance of the BWC. Further, in order to allow the powdery activated carbon to be stably present in the non-woven fabric with being adhered and/or captured therein, the above-described optional characteristics of the synthetic fiber according to the present invention are significant. As a result, adsorption/desorption effects may be markedly increased and stable effects of capturing the activated carbon may be achieved. Therefore, synergistic effects of the synthetic fiber and the powdery activated carbon may be expected.

As such, the present invention preferably uses the above-described specific synthetic fiber, such that it is possible to surprisingly exhibit advantageous effects such as a prevention of release of the activated carbon, a control of a thickness during the heat compressing process, and an execution of smooth ultrasonic fusion of the engine air cleaner.

According to the preferred embodiment of the present invention, the specific synthetic fiber may be used in a composition of 10 to 30% by weight (‘wt. %’). If an amount of the synthetic fiber used herein is too small, the activated carbon could not be sufficiently applied. When an excess of the synthetic fiber is used, a content of the activated carbon per unit volume is decreased in inverse proportion, and therefore, improvement of the adsorption/desorption effects may not be expected.

According to the preferred embodiment of the present invention, if using the melting point fine fiber among the synthetic fibers, it is preferable to add a water repellent agent having good dispersion to the melting point fine fiber, in order to improve dispersion of the melting point fine fiber and to prevent inflow of moisture into the powdery activated carbon. In this case, the water repellent agent may be one that does not block a pore structure of the activated carbon and can minimize suppression of water absorption.

Further, the present invention uses a carbon binder. This is used for adhering and fixing the powdery activated carbon to the synthetic fiber and for preventing release of the same. For example, the carbon binder used herein may include, for example, at least one selected from an acryl resin, a polyvinyl acetate (PVAC) resin, a polyvinyl alcohol (PVA) resin or powders, a starch (CMC), phenol resin, an ethylvinyl acetate (EVA) resin or powders, and polyethylene (PE) powders.

According to the present invention, if an amount of the used carbon binder is too small, release of the activated carbon particles may occur. When the amount thereof is too much, adsorption efficiency may be considerably reduced due to blocking of the pores in the activated carbon.

Preferably, the present invention may minimize a content of the above-described carbon binder. The reason is that the powdery activated carbon as well as the synthetic fiber having specific physical properties may be desirably selected and used as described above, and thereby manufacturing the inventive fabric with the desired composition having a reduced amount of the carbon binder used herein to a minimum.

According to the preferred embodiment of the present invention, in addition to the basic materials, an additive such as a dispersant may be included in an amount of 0.05 to 0.2 wt. % based on a total composition of the wet-laid non-woven fabric. The dispersant used herein may be a modified starch or any one of other typical dispersants. Further, the water repellent agent used as the additive may include, for example, any typical water repellent agent such as silane, siloxane, and siliconate-based agents, etc., which may be used in an amount of 0.2 to 1.0 wt. %.

Further, according to the preferred embodiment of the present invention, in order to reduce a loss rate of the activated carbon and improve the activated carbon adsorption/desorption effects, a carbon fixing agent and a dehydration enhancer may be further used as additional components. The carbon fixing agent used herein is preferably an amine-based polymer such as 1,2-ethane diamine. Such a carbon fixing agent may be contained in an amount of 0.05 to 1.0 wt. % based on a total composition of the wet-laid non-woven fabric. If the amount thereof used herein is too small, no particular effect is achieved by adding the same. When the amount thereof used herein is too large, adsorption/desorption effects may be inhibited.

Furthermore, the dehydration enhancer also useable as the additive may include, for example, amides such as polyacryl amide and a content thereof used herein may range from 0.05 to 1.0 wt. %. In this case, if an amount thereof used herein is too small, dehydration enhancing effects cannot be expected. On the other hand, if the amount thereof used herein is too large, adsorption/desorption effects may be rather inhibited.

According to the preferred embodiment of the present invention, in the method for manufacturing the wet-laid non-woven fabric for a hydrocarbon trap of an air cleaner for a gasoline engine according to the present invention as described above, a sheet type or roll type fabric is formed through the heat compressing process S150 using a rolling roller, such that a product having a weight of 300 to 800 g/m² and a thickness of 2.2 to 3.6 mm immediately before the heat compressing process S150 is preferably pressed and molded so as to have a thickness of 0.6 to 1.8 mm whiling maintaining the same weight of 300 to 800 g/m² through the heat compressing process S150. This means that the product is pressed so as to reduce the volume ½ its original size through heat pressing with no change in weight. If the pressing is conducted too much, absorption/desorption effects may be rather reduced.

Alternatively, the method for manufacturing the wet-laid non-woven fabric for a hydrocarbon trap of an air cleaner for a gasoline engine according to the present invention may include closely adhering a dry non-woven fabric made of a synthetic fiber to any one surface of the wet-laid non-woven fabric, and then forming the same into a sheet type or roll type synthetic non-woven fabric through the heat compressing process S150.

According to the preferred embodiment of the present invention, while closely adhering the dry non-woven fabric to any one surface of the wet-laid non-woven fabric for a hydrocarbon trap of an air cleaner for a gasoline engine as described above, the above fabric may undergo the heat compressing process S150 so as to be formed in a sheet type or roll type synthetic non-woven fabric. In this case, the fabric may be configured so as to be installed in the air cleaner. Further, the fabric may be more stably fused and fixed on the housing of the air cleaner through ultrasonic fusion.

According to the preferred embodiment of the present invention, in consideration of the loss rate of activated carbon and butane working capacity (BWC) of the wet-laid non-woven fabric for a hydrocarbon trap, on which the processes from the suspension process S110 to the drying process S140 are completed, it is preferable to use powdery activated carbon having specific physical properties, in which the meso-structure as described above is contained in a specific range.

Further, in a case of the air cleaner for a gasoline engine, the engine may be damaged when particles having a particle size of 200 μm inflow into the engine, therefore, the powdery activated carbon having a particle size of 20 to 150 μm is used. During water suction through a mesh net in the suspension process S110, the powdery activated carbon may come out along with the water to increase the loss rate thereof. Therefore, in order to reduce the loss rate of the powdery activated carbon, additionally using a carbon fixing agent is preferably considered. As such, the additive additionally used in the present invention may partially serve to further improve the physical properties of the wet-laid non-woven fabric.

In addition, according to the preferred embodiment of the present invention, with regard to the heat compressing process S150, when using the activated carbon, pulp, the synthetic fiber and the carbon binder and/or any other additional components, the raw materials mixed with the additives listed above have a problem in which these components are not completely combined after drying the resulting fabric. Therefore, during the fabric is mounted and used in the air cleaner for a gasoline engine, it is necessary to prevent desorption of the raw materials which were used in manufacturing the wet-laid non-woven fabric. For this purpose, it is preferable to conduct the heat compressing process. However, if the fabric has a high thickness after the heat compressing process, pressure loss in a flow path is increased to increase consumption of the fuel. Therefore, it is preferable to reduce the thickness to a minimum by performing the heat compressing process.

An example according to the present invention is to prepare a fabric using the basic materials of the present invention through suspension and web forming processes. If the fabric is formed in a paper formation mode, a dehydration time is less involved therein. On the other hand, a succession of lines in a mechanical mode has a limitation in suction. Thus, it is possible to manufacture the fabric when increasing a suction capacity. Further, according to another preferred example, it is preferable that bi-fold fabrics are at first prepared, respectively, and then combined together.

Further, it is preferable to press the fabric by a multi-stage press in both the paper fabrication mode and the mechanical mode to decrease the thickness thereof.

In this case, according to the preferred embodiment of the present invention, the thickness of the fabric should be decreased at least by ½ its original thickness during the heat compressing process. Basically, since it is a limited to decrease the thickness even after the suction process, using the synthetic fiber under specific conditions according to the present invention may achieve the desired results. For example, a melting point fine fiber or the synthetic fibers selected and used according to the present invention as illustrated above are preferably used. In order to prevent release of the activated carbon in the fabric manufacturing process, the heat compressing process is preferably conducted at a high temperature of 150° C. to 260° C. with a high pressure of 30 N/cm² to 300 N/cm² to compress the fabric.

As such, the wet-laid non-woven fabric for a hydrocarbon trap of an air cleaner for a gasoline engine, which is manufactured by the above-described manufacturing method, may capture hydrocarbon in evaporation gases generated from a fuel in a combustion chamber of an engine or a fuel storage tank during driving or stoppage of a vehicle, or to recover the captured hydrocarbon to the engine so as to be rebumed therein, therefore, may be applied to a hydrocarbon trap equipped for adsorption/desorption of volatile oil vapor in an air cleaner for an engine of a vehicle by any typical method.

Therefore, the present invention includes a hydrocarbon trap for an air cleaner in a gasoline engine, which includes the above-described wet-laid non-woven fabric for a hydrocarbon trap of an air cleaner for a gasoline engine according to the present invention.

Hereinafter, the present invention will be described in detail by means of the following examples, however, it is not limited thereto.

Hereinafter, various tests are performed on an air cleaner to which the wet-laid non-woven fabrics manufactured in each of the examples and comparative examples are applied as follows: an activate carbon performance test of the powdery activated carbon in regard to the above air cleaner (Experimental Example 1); an experimental test for assessing the loss rate of activated carbon of the wet-laid non-woven fabric for a hydrocarbon trap obtained after completing the processes from the suspension process S110 to the drying process S140 (Experimental Example 2); a BWC test for assessing the butane working capacity (BWC) efficiency (Experimental Example 3); and an ultrasonic fusion test (Experimental Example 4), in regard to the wet-laid non-woven fabric for a hydrocarbon trap obtained after completing the entire manufacturing process from the suspension process S110 to the heat compressing process S150, etc., which will be described below for each step.

### PREPARATIVE EXAMPLES 1 TO 6, AND COMPARATIVE PREPARATIVE EXAMPLES 1 TO 4

With the configurations shown in Table 1 below, powdery activated carbon used for manufacturing a wet-laid non-woven fabric for a hydrocarbon trap of an air cleaner for a gasoline engine was prepared.

### Experimental Example 1: Activated Carbon Performance Test of Powdery Activated Carbon

In order to conduct a performance test of adsorption/desorption abilities on the powdery activated carbon prepared in each of the preparative examples and comparative preparative examples, baking was performed at 110° C. for 3 hours before the test, and by using a standard jig for test, 500 ml of activated carbon was filled at room temperature under normal pressure (25° C.±2° C., 1 atm) and 50±5% RH. Then, after loading 250 cc/min of N2 gas and 250 cc/min of butane gas, it was subjected to measurement until saturation, followed by purging the same with 25.5 l/min to reach a minimum mass. Results of the above procedures are shown in Table 1 below.

TABLE 1

| | | | | BWC |
|---|---|---|---|---|
| | Meso- | Specific | | adsorption/ |
| | structure | surface area | BWC mass/ | desorption |
| Section | (%) | (m²/g) | Carbon mass | Efficiency (%) |
| Preparative | 88.1 | 2,500 | 0.23 | 95.81 |
| Example 1 | | | | |
| Preparative | 80.0 | 2,393 | 0.22 | 93.79 |
| Example 2 | | | | |
| Preparative | 75.3 | 2,100 | 0.19 | 89.00 |
| Example 3 | | | | |
| Preparative | 54.0 | 1,800 | 0.18 | 84.80 |
| Example 4 | | | | |
| Preparative | 45.3 | 1,500 | 0.17 | 83.10 |
| Example 5 | | | | |
| Preparative | 80.0 | 1,800 | 0.19 | 85.12 |
| Example 6 | | | | |
| Comparative | 92.1 | 2,500 | 0.23 | 93.90 |
| Preparative | | | | |
| Example 1 | | | | |
| Comparative | 30.2 | 1,500 | 0.09 | 45.21 |
| Preparative | | | | |
| Example 2 | | | | |
| Comparative | 25.5 | 1,100 | 0.05 | 36.60 |
| Preparative | | | | |
| Example 3 | | | | |
| Comparative | 50.5 | 800 | 0.11 | 57.36 |
| Preparative | | | | |
| Example 4 | | | | |

Referring to activated carbon performance test of the powdery activated carbon described above (Experimental Example 1), it could be seen that, as the specific surface area of the activated carbon and the content of meso-structure in the activated carbon were larger, butane gas adsorption ability was higher and, when the content of meso-structure was decreased, the butane gas adsorption ability was reduced. Further, in consideration of adsorption/desorption abilities in the composition of the wet-laid non-woven fabric, it is advantageous if the specific surface area of the powdery activated carbon is larger. However, it was found that the content of meso-structure was much more effective than the specific surface area upon the adsorption/desorption abilities.

That is, as a butane gas capture weight (g) per 1 g of activated carbon is higher, the capture ability is more excellent.

For reference, the wet-laid non-woven fabric is mounted in the air cleaner for a gasoline engine to conduct adsorption during stoppage of a vehicle and desorption during driving, and therefore, is semi-permanently used until the vehicle is scrapped. Thereby, it is ideal that a sum of adsorption efficiency and desorption efficiency thereof is close to 99%.

In addition, with reduced adsorption/desorption abilities, the butane gas remains with being captured in the activated carbon and is not completely desorbed. Therefore, in order to use the fabric semi-permanently, a hydrocarbon trap (HC) which repeats completely desorbing the butane gas and then adsorbing the same again still has a limitation.

Moreover, as the meso-structure and the specific surface area is increased, the butane adsorption capacity is increased, and adsorption/desorption abilities are also increased. However, it was found that, even though the meso-structure is larger than 90%, further improvement in adsorption/desorption abilities was not substantially expected. The above experimental results indicate that unfavorable results may be caused in consideration of non-economic advantage in production of the powdery activated carbon containing more than 90% of meso-structure.

In fact, the inventive fabric should be used semi-permanently as a hydrocarbon trap (HC Trap) component provided in the air cleaner for an engine in a vehicle. For this purpose, the fabric continuously conducts adsorption and desorption.

That is, since adsorption is again performed when the engine is stopped, while butane is again sucked into the engine by inflow of air into the engine during driving, 100% adsorption/desorption efficiency is most ideally preferred. However, in terms of the production and structure of activated carbon, it is not possible to produce activate carbon including 100% meso-structure.

In particular, even though the powdery activated carbon includes more than 90% meso-structure, functional effects are not much improved, whereas the product has no economic advantage due to difficulties in production and high production costs. Therefore, it could be found that the activated carbon with 90% or less of meso-structure was preferably used.

### EXAMPLES 1 TO 4

Basic materials used in these examples are as follows: 340 g/m² of the powdery activated carbon having a particle size of 90 μm prepared in Preparative Example 2; 15 g/m² of pulp; 80 g/m² of melting point fine fiber (10 μm) at 110° C.; 1.3 g/m² of a water repellent agent; 45 g/m² of a carbon binder (Hercopuls™ 125 of Ashland Co.); and 20 g/m² of a non-woven fabric support. Further, other additives are also used in these examples. The above basic materials were subjected to a suspension process S110 of preparing a suspension by mixing the basic materials, followed by a web formation process S120 to form a web type product. Then, the web product was dried in a drying process S140 after passing through a water removal process S130. Herein, among the additives, a carbon fixing agent or a dehydration enhancer was used in Examples 1 to 4, while including the basic materials, respectively. The carbon fixing agent used herein was SY CHEM SB-50N (manufactured by SY CHEM Co.), and the dehydration enhancer was SY CHEM C-100 (manufactured by SY CHEM Co.). According to the above procedures, wet-laid non-woven fabrics for a hydrocarbon trap of an air cleaner for a gasoline engine, which have the compositions listed in Table 2 below, were manufactured.

### Experimental Example 2: Test for Assessing Loss Rate of Activated Carbon of Wet-Laid Non-Woven Fabric For a Hydrocarbon Trap, on Which Processes from the Suspension Process S110 to the Drying Process S140 are Completed

With regard to the fabrics manufactured in each of the examples 1 to 4, a difference (that is, deviation) between a weight before introduction and a weight after introduction was used to measure loss of the activated carbon. Results thereof are shown in Table 2 below.

TABLE 2

| | Example 1 | Example 2 | | |
|---|---|---|---|---|
| | Carbon fixing | Carbon fixing | | |
| | agent 0.6% + | agent 0% + | Example 3 | Example 4 |
| | dehydration | Dehydration | Carbon fixing | Dehydration |
| Section | enhancer 0.5% | enhancer 0% | agent 0.8% | enhancer 0.5% |
| Dehydration | 4.5 | 6.8 | 5.40 | 5.2 |
| time (sec) | | | | |
| Weight of fabric | 500.4 | 510.4 | 506.2 | 520.1 |
| (g/m²) | | | | |
| Weight of loss | 14.96 | 68.68 | 45.9 | 29.92 |
| (g/m²) | | | | |
| Loss of activated | 4.4 | 20.2 | 13.5 | 8.8 |
| carbon (%) | | | | |

### EXAMPLES 5 TO 8, AND COMPARATIVE EXAMPLES 1 AND 2

After preparing the fabrics according to the same procedures as described in Example 2, the prepared fabrics were subjected to a heat compressing process S150 to undergo heat compressing and molding under conditions of 150° C. to 230° C. with 30 N/cm² to 160 N/cm², thereby manufacturing wet-laid non-woven fabrics. As a result, wet-laid non-woven fabrics for a hydrocarbon trap of an air cleaner for a gasoline engine, which have the compositions listed in Table 3 below, were manufactured.

As comparative examples, wet-laid non-woven fabrics were manufactured in a method using different contents of meso-structure in the activated carbon, different contents of activated carbon and different thicknesses of the fabrics.

### Experimental Example 3

BWC performance test for reviewing butane working capacity (BWC) efficiency performed on the wet-laid non-woven fabric for a hydrocarbon trap, on which manufacturing processes from the suspension process S110 to the heat compressing process S150 are finally competed.

With regard to the fabrics manufactured in Examples 5 to 8 and Comparative Examples 1 to 2, Butane Working Capacity (BWC) performance test was conducted by the following processes: the fabric in a volume of 0.031 m², was stabilized by suction of dry and clean air at 28.5±0.5 l/min using a standard jig for test in a forced convection oven at 110±5° C. for 3 hours, followed by termination when a change in a weight is less than 0.1 g/10 min; the treated product was loaded by suction of a sample in a butane suction device (50% butane+50% nitrogen) at 176 ml/min, followed by termination when a change in a weight is less than 0.01 g/10 min and measurement of the weight; the treated product was subjected to desorption through suction (i.e., purging) of a dry and clean air at 42 l/min, followed by termination when a change in the weight is less than 0.01 g/10 min and measurement of the weight. These procedures were repeated three times to obtain an average. Results of the present experiment are shown in Table 3 below.

TABLE 3

| | | Comparative | | | | Comparative |
|---|---|---|---|---|---|---|
| Section | Example 5 | Example 1 | Example 6 | Example 7 | Example 8 | Example 2 |
| Weight of fabric | 500 | 500 | 550 | 550 | 550 | 330 |
| (g/m²) | | | | | | |
| Thickness of | 1.4 | 1.4 | 1.6 | 1.6 | 2.6 | 0.7 |
| fabric (mm) | | | | | | |
| Weight of | 340 (68%) | 340 (68%) | 340 (61.8%) | 300 (54.5%) | 300 (54.5%) | 214.5 (65%) |
| activated carbon | | | | | | |
| (g/m²) | | | | | | |
| Specific surface | 2,390 | 1,501 | 2,389 | 2,395 | 2,393 | 2,396 |
| area (m²/g) | | | | | | |
| Meso-structure | 80 | 30 | 80 | 80 | 80 | 80 |
| (%) | | | | | | |
| Test filtration area | 0.031 | | | | | |
| (m²) | | | | | | |
| BWC (g) | 3.45 | 1.52 | 3.33 | 3.01 | 3.04 | 1.78 |

As a result of analyzing the above experimental results, in consideration of the results as well as the experimental results in Experimental Example 1 proposed by the above preparative examples, it was confirmed that, if selecting the powdery activated carbon containing meso-structure in a specific range and using it a predetermined range, test results of BWC performance exhibited remarkably excellent characteristics.

Further, the heat compressing process S150 allows the fabric to be used at a typical flow rate of 2.8 m²/min for a gasoline engine since the activated carbon, pulp, the synthetic fiber, the carbon binder and the additive are not completely combined after drying, and further allows the fabric to be mounted in an air cleaner for a gasoline engine to prevent desorption of the fuel. Furthermore, since a pressure loss in a flow path is increased to cause an increase in combustion of the fuel if the fabric has a large thickness, it was confirmed that the heat compressing process was preferably conducted to minimize the thickness.

### EXAMPLE 9, AND COMPARATIVE EXAMPLES 3 TO 6

The same activated carbon as Example 2, and a melting point fine fiber having a diameter of 30 μm or less or a melting point of 110° C. as a synthetic fiber were used. For comparative examples, other different synthetic fibers (or fibers having a diameter of more than 30 μm or different melting points or physical properties) were used, and under the conditions shown in Table 4 below, respective wet-laid non-woven fabrics were manufactured.

### Experimental Example 4: Ultrasonic Fusion Test

An experiment of release and adhesion of HC Trap fabric to a housing of the engine air cleaner was executed by an ultrasonic fusion test of the wet-laid non-woven fabrics produced in Example 9 and Comparative Examples 3 to 6.

Then, in order to assess whether the HC Trap fabric can be semi-permanently used, physical properties thereof were measured. The test was conducted according to a vehicle standard ESIR breakaway test method. While altering a weight of the fabrics and a thickness of the fabrics, ultrasonic fusion strengths were measured. Results of the measurement are shown in Table 4 below.

TABLE 4

| | | Comparative | Comparative | Comparative | Comparative |
|---|---|---|---|---|---|
| Section | Example 9 | Example 3 | Example 4 | Example 5 | Example 6 |
| Synthetic fiber | Melting point | Melting point | Melting point | Normal fiber | Inorganic fiber |
| | 110° C. | 90° C. | 280° C. | 35 μm | 30 μm |
| | Microfiber | Microfiber | Microfiber | 80 g/m² | 80 g/m² |
| | 10 μm | 10 μm | 10 μm | | |
| | 80 g/m² | 45 g/m² | 80 g/m² | | |
| Weight of fabric | 500 | 465 | 500 | 500 | 500 |
| (g/m²) | | | | | |
| Thickness of fabric | 1.4 | 1.3 | 1.8 | 2.4 | 2.8 |
| (mm) | | | | | |
| Weight of activated | 340 (68%) | | | | |
| carbon (g/m²) | | | | | |
| Ultrasonic fusion | 8.0 | 5.2 | 4.3 | 2.0 | 0.5 |
| strength | | | | | |
| (kgf/Φ35 mm) | | | | | |

Referring to the above experiment, it could be seen that using the melting point fine fiber within the corresponding range as a synthetic fiber (Example 9) exhibited superior and excellent bonding characteristics, as compared to cases of not using the same (Comparative Examples 3 to 6). Such a result demonstrated that the wet-laid non-woven fabric has excellent effects of preventing release of powdery activated carbon and excellent product reliability. Therefore, it is evident that, when applying the present product to a hydrocarbon trap, improvement of volatile oil vapor adsorption/desorption effects may also be sustained for a long period of time.

As described above, according to the wet-laid non-woven fabric for a hydrocarbon trap of an air cleaner for a gasoline engine, basic materials such as powdery activated carbon, pulp, a synthetic fiber and a carbon binder are used, and if necessary, additives such as a dispersant, a water repellent agent, a carbon fixing agent, etc. may be added. Through the compressing process, a wet-laid non-woven fabric having a predetermined thickness is manufactured and installed in an air cleaner for a gasoline engine, in order to capture hydrocarbon gas contained in evaporation gases generated from a fuel in a combustion chamber of the engine or a fuel storage tank during stoppage of the engine on a side of the wet-laid non-woven fabric for a hydrocarbon trap, as well as, recover the hydrocarbon captured in the wet-laid non-woven fabric for hydrocarbon during stoppage of the engine into the engine with a negative pressure at startup of the engine when the vehicle is driven, so as to be rebumed in the engine.

Moreover, since the wet-laid non-woven fabric is composed of the basic materials such as powdery activated carbon, pulp, a synthetic fiber and a carbon binder, as well as additives such as a dispersant, a water repellent agent, a carbon fixing agent and a dehydration enhancer, and is formed into a wet-laid non-woven fabric having a predetermined thickness through the compressing process, the fabric may capture hydrocarbon in evaporation gases discharged during driving or stoppage of the vehicle so as to prevent release of the hydrocarbon which is a main cause of air pollution to an outside, and damage caused by the hydrocarbon to a passenger in the vehicle may be minimized.

While the present invention has been described with reference to the specific examples, the present invention is not limited thereto, and it will be understood by those skilled in the related art that various modifications and variations may be made therein without departing from the scope of the present invention as defined by the appended claims, as well as these modifications and variations will be included in the scope of the present invention.

What is claimed is:

1. A wet-laid non-woven fabric for a hydrocarbon trap of an air cleaner for a gasoline engine, which is installed in the air cleaner for a gasoline engine to capture hydrocarbon in evaporation gases generated from a fuel in a combustion chamber of an engine or a fuel storage tank during driving or stoppage of a vehicle, or to recover the captured hydrocarbon to the engine so as to be reburned therein, the wet-laid non-woven fabric comprising:
basic materials including powdery activated carbon, pulp, a synthetic fiber and a carbon binder, wherein the powdery activated carbon has an average particle size in a range of 20 to 150 μm and contains 45 to 90% of meso-structure, and the synthetic fiber has a diameter of 30 μm or less and a melting point of 110° C. to 270° C.

2. The wet-laid non-woven fabric according to claim 1, wherein the synthetic fiber includes at least one synthetic fiber selected from an ultra-fine fiber, a fine fiber, a split fine type fiber, and a sea-island type fiber; or at least one selected from sheath/core or side by side type composite melting point fibers which are selected from PP/PE, PET/PE, PET/PP and PET/Nylon.

3. The wet-laid non-woven fabric according to claim 1, wherein the basic materials include 45 to 80 wt. % of the powdery activated carbon, 3 to 13 wt % of the pulp, 10 to 30 wt. % of the synthetic fiber and 3 to 12 wt. % of the carbon binder.

4. The wet-laid non-woven fabric according to claim 3, further comprising: in addition to the basic materials, at least one of 0.05 to 2.0 wt. % of a dispersant, 0.2 to 1.0 wt. % of a water repellent agent, 0.05 to 1 wt. % of a carbon fixing agent and 0.05 to 1.0 wt. % of a dehydration enhancer based on a total composition of the non-woven fabric.

5. The wet-laid non-woven fabric according to claim 1, wherein the powdery activated carbon has a specific surface area of 1,000 to 3,000 m²/g.

6. A method for manufacturing a wet-laid non-woven fabric for a hydrocarbon trap of an air cleaner for a gasoline engine, which is installed in the air cleaner for a gasoline engine to capture hydrocarbon in evaporation gases generated from a fuel in a combustion chamber of an engine or a fuel storage tank during driving or stoppage of a vehicle or to recover the captured hydrocarbon to the engine so as to be rebumed therein, the method comprising:
preparing basic materials which include powdery activated carbon, pulp, a synthetic fiber and a carbon binder, wherein the powdery activated carbon used herein has an average particle size in a range of 20 to 150 μm and contains 45 to 90% of meso-structure, and the synthetic fiber used herein has a diameter of 30 μm or less and a melting point of 110° C. to 270° C.;
passing the basic materials through a suspension process to prepare a suspension;
subjecting the basic materials passed through the suspension process to a web formation process to form a web type product;
subjecting the web type product to a water removal process;
drying the web type product in a drying process after the water removal process; and
subjecting the web type product after the drying process to a heat compressing process to conduct heat compressing and molding, so as to form a sheet type or roll type fabric.

7. The method according to claim 6, wherein the synthetic fiber uses at least one synthetic fiber selected from an ultra-fine fiber, a fine fiber, a split fine type fiber, and a sea-island type fiber; or at least one selected from sheath/core or side by side type composite melting point fibers which are selected from PP/PE, PET/PE, PET/PP and PET/Nylon.

8. The method according to claim 6, wherein the basic materials include 45 to 80 wt. % of the powdery activated carbon, 3 to 13 wt % of the pulp, 10 to 30 wt. % of the synthetic fiber and 3 to 12 wt. % of the carbon binder.

9. The method according to claim 7, wherein the wet-laid non-woven fabric further comprises, in addition to the basic materials, at least one of 0.05 to 2.0 wt. % of a dispersant, 0.2 to 1.0 wt. % of a water repellent agent, 0.05 to 1 wt. % of a carbon fixing agent and 0.05 to 1.0 wt. % of a dehydration enhancer based on a total composition of the non-woven fabric.

10. The method according to claim 6, wherein the heat compressing process is a process of heat pressing and molding the product that has a weight of 300 to 800 g/m² and a thickness of 2.2 to 3.6 mm through the heat compressing process so as to have a thickness of 0.6 to 1.8 mm while maintaining the same weight of 300 to 800 g/m².
